(19) United States
(12) Patent Application Publication
(10) Pub. No.: US 2011/0283992 A1
(43) Pub. Date: Nov. 24, 2011

(54) Cooking apparatus with pivoting shelf and hidden griddle

(76) Inventor: Robert DeMars, La Quinta, CA (US)

(21) Appl. No.: 12/800,524

(22) Filed: May 18, 2010

(51) Int. Cl. A47J 37/07; F24C 15/12

(52) U.S. Cl. 126/41 R; 126/39 B

(57) ABSTRACT

A cooking apparatus is provides, and the apparatus comprising: a firebowl having a peripheral edge, a bottomside, a topside opening and at least one aperture; at least one grill situated over the topside opening of the firebowl; at least one shelf having a topside surface and an underside designed to receive a griddle, and the shelves having a protrusion designed to fit and pivotally rotate within the apertures of the firebowl allowing each of the shelves to be rotated in a first position situated over the grill and a second position away from the grill, the aperture of the firebowl is situated adjacent a portion of the peripheral edge of the firebowl; and at least one griddle designed to be received within the underside of the shelf during a storage position, and the griddle may be placed upon a topside surface of the grill during a usage position.

### BACKGROUND OF THE INVENTION

1. Field of the Invention

The present invention relates to cooking apparati, and more particularly to barbecues having pivoting shelves with hidden griddles.

2. Description of the Related Art

It is known in the art to provide a cooking appliance having one or more shelves associated therewith. The shelves may be movably attached to the barbecue so that they can be moved into a position of use such as outside of the barbecue for storage of food and implements thereon, and also movable into a position for storage of foods and implements thereon, and also movable into a position for storage of the shelves such as at the inside of the barbecue.

### SUMMARY OF THE INVENTION

In one embodiment, the present invention provides for a cooking apparatus comprising: a firebowl having a peripheral edge, a bottomside and a topside opening; at least one grill situated over or upon the topside opening of said firebowl; at least one shelf having a topside surface and an underside designed to receive a griddle; and at least one griddle designed to be received within the underside of the shelf during a storage position, and the griddle is placed upon a topside surface of the grill during a usage position.

In another embodiment, the firebowl has at least on aperture situated within the topside opening of the firebowl or situated adjacent at least a portion of said peripheral edge of said firebowl. In still another embodiment, the shelf comprising opposing ends, and at least one end comprises a protrusion. In yet another embodiment; the protrusion of the shelf is designed to fit within the aperture of the firebowl. In still yet another embodiment, the protrusion is designed to rotate within the aperture of firebowl allowing the shelf to be pivotable and moveable. In a further embodiment, the shelf is situated above or over the topside opening of firebowl during a non-use position, and the shelf is pivotally moved away from the topside opening during a use position.

In another further embodiment, the underside of the shelf comprises at least two extended portions with lips situated on opposing sides of the underside of the shelf. In yet a further embodiment, the two extended portions with lips of the underside of the shelf form a space for receiving the griddle.

In still a further embodiment, the apparatus further comprises a cover pivotally attached a portion of the firebowl or a portion of the peripheral edge of the firebowl. In still yet a further embodiment, the apparatus further comprises a means for supporting the shelf during the use position. In another embodiment, the means is selected from a group consisting essentially of a base, a handle and a framework.

In yet another embodiment, the present invention relates to a cooking apparatus comprising: a firebowl having a peripheral edge, a bottomside, a topside opening and at least on aperture situated within the topside opening of the firebowl; at least one grill situated over the topside opening of said firebowl; at least one shelf having a topside surface, an underside and opposing ends, at least one end of the shelf comprises a protrusion, and the protrusion is designed to fit within and pivotally rotate within the aperture allowing the shelf to be situated above or over the topside opening of the firebowl during a non-use position and then pivotally moved away from the topside opening during a use position.

In still another embodiment, the aperture is formed by a cylindrical element situated within the firebowl. In still yet another embodiment, the protrusion of the shelf comprises a pin and a cap, and the pin is designed to fit and rotate within the cylindrical element. In a further embodiment, the cap is situated on a top portion of the pin and is designed to cover the cylindrical element.

In another further embodiment, the apparatus further comprises at least one griddle, and the griddle is designed to fit on the underside of the shelf.

In yet another further embodiment, the underside of the shelf comprises at least two extended portions with lips situated on opposing sides of the underside of the shelf, and the two extended portions with lips of the underside of the shelf form a space for receiving the griddle.

In another embodiment, the apparatus further comprises a cover pivotally attached to a portion of said firebowl. In yet another embodiment, the apparatus further comprises a means for supporting the shelf during the use position, and the means is selected from a group consisting essentially of a base, a handle and a framework.

In still another embodiment, the present invention provides for a cooking apparatus comprising: a firebowl having a peripheral edge, a bottomside, a topside opening and at least two apertures; at least one grill situated over the topside opening of the firebowl; at least two shelves having a topside surface and an underside designed to receive a griddle, each of the shelves having a protrusion designed to fit and pivotally rotate within each of the apertures of the firebowl allowing each of the shelves to be rotated in a first position situated over the grill and a second position away from the grill, the apertures of the firebowl are situated adjacent a portion of the peripheral edge of the firebowl; and at least two griddles designed to be received within the underside of each of the shelves during a storage position, and each of the griddles may be placed upon a topside surface of the grill during a usage position. In a further embodiment, the underside of the shelf has a detent for holding the griddle in place during storage or transport.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a perspective view of a barbecue cooking apparatus with pivoting shelves in accordance with the invention;

FIG. 2 is a perspective view of FIG. 1 showing one of the shelves moving from a first position above the grill and opened topside of the firebowl to a second position away from the topside of the firebowl;

FIG. 3 is a perspective view of FIGS. 1-2 showing the shelves in a use position;

FIG. 4 is a partial exploded view of FIGS. 1-2 showing the shelf and the aperture of the firebowl;

FIG. 5 is a perspective view of the apparatus of the present invention showing the hidden griddles;

FIG. 6 is an underside view of the griddle being stored in the shelf;

FIG. 7 is a perspective view of the barbecue with the shelves in use and the griddles on the grill; and

FIG. 8 is a perspective view of FIG. 7 with the legs of the barbecue in an extended position.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

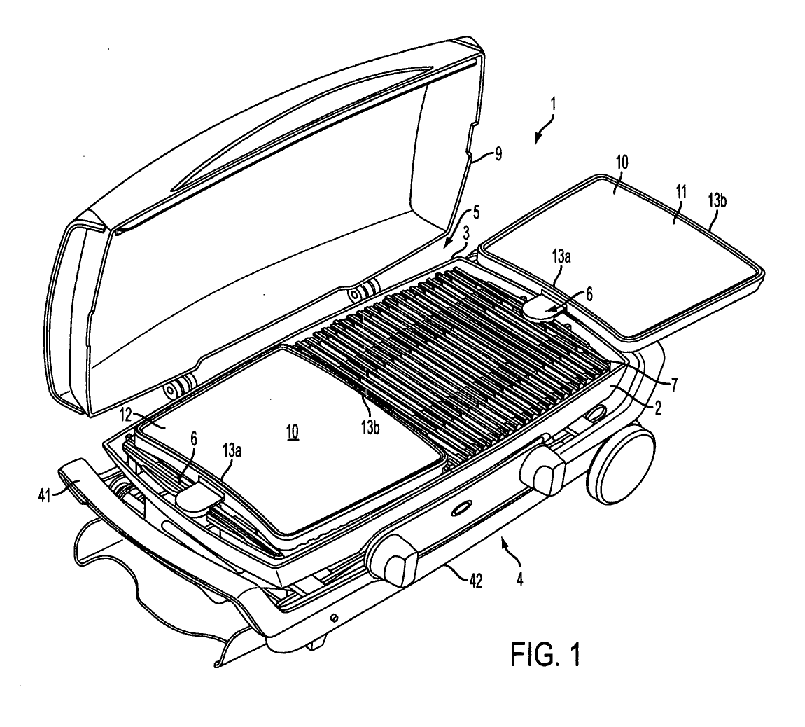

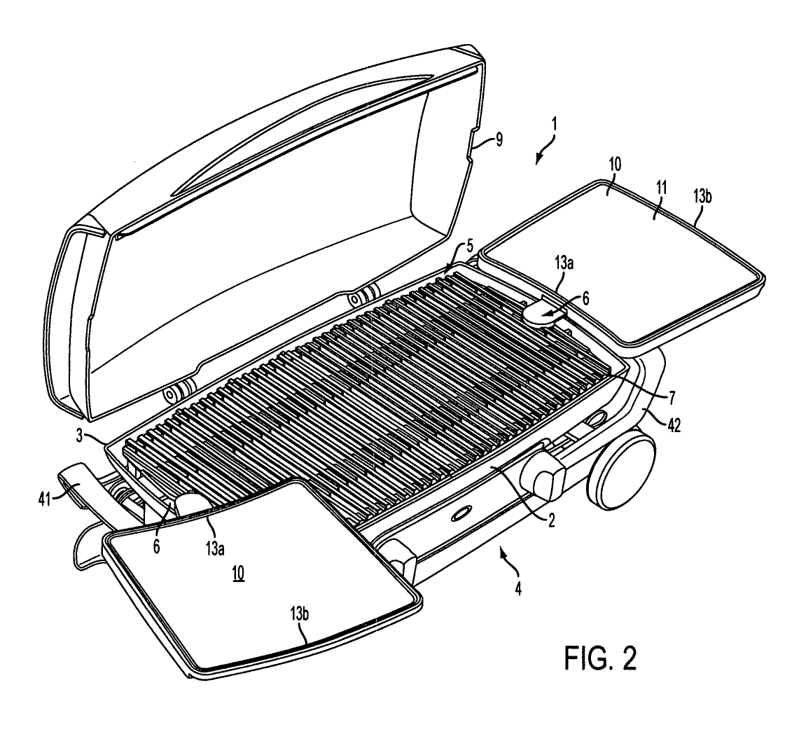

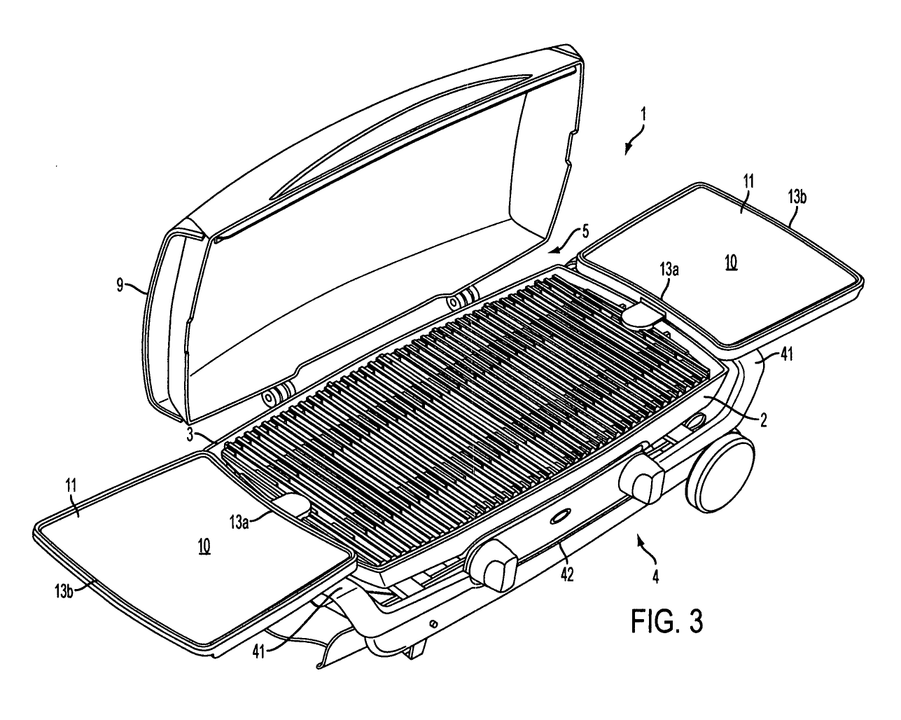

FIGS. 1-4 show a barbecue a cooking apparatus 1. The apparatus 1 comprises a firebowl 2 having a peripheral edge 3, a bottomside 4, a topside opening 5 and at least on aperture 6 situated within the topside opening 5 of the firebowl 2. The apparatus 1 further comprises at least one grill 7 situated over the topside opening 5 of said firebowl 2. There is also at least one shelf 10 having a topside surface 11, an underside 12 and opposing ends, 13a-b respectively, and at least one end 13a of the shelf 10 comprises a protrusion 14. The protrusion 14 is designed to fit within and pivotally rotate within the aperture 6 allowing the shelf 10 to be situated above or over the topside opening 5 of the firebowl 2 during a non-use position and then pivotally moved away from the topside opening 5 during a use position.

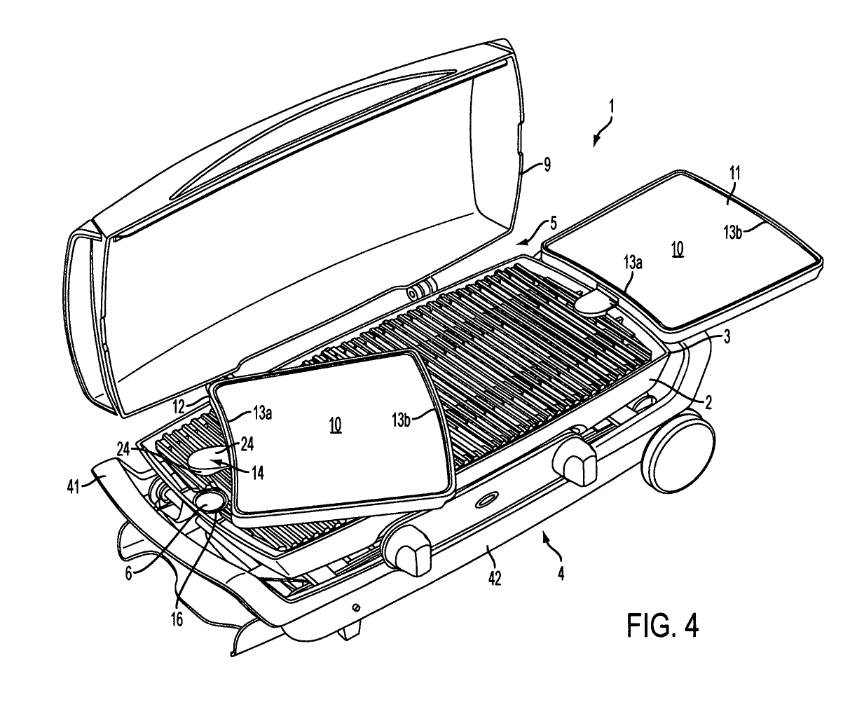

FIG. 4 shows that the aperture 6 is formed by a cylindrical element 16 situated within the firebowl 2. The protrusion 14 of the shelf 10 comprises a pin 24 and a cap 34, and the pin 24 is designed to fit and rotate within the cylindrical element 16. The cap 34 is situated on a top portion of the pin 24 and is designed to cover the cylindrical element 16.

The apparatus 1 further comprises a cover 9 pivotally attached a portion of the firebowl 2 or a portion of the peripheral edge 3 of the firebowl 2. The apparatus 1 further comprises a means for supporting the shelf 10 during the use position. In this one embodiment, the means is a handle 41 and a framework 42.

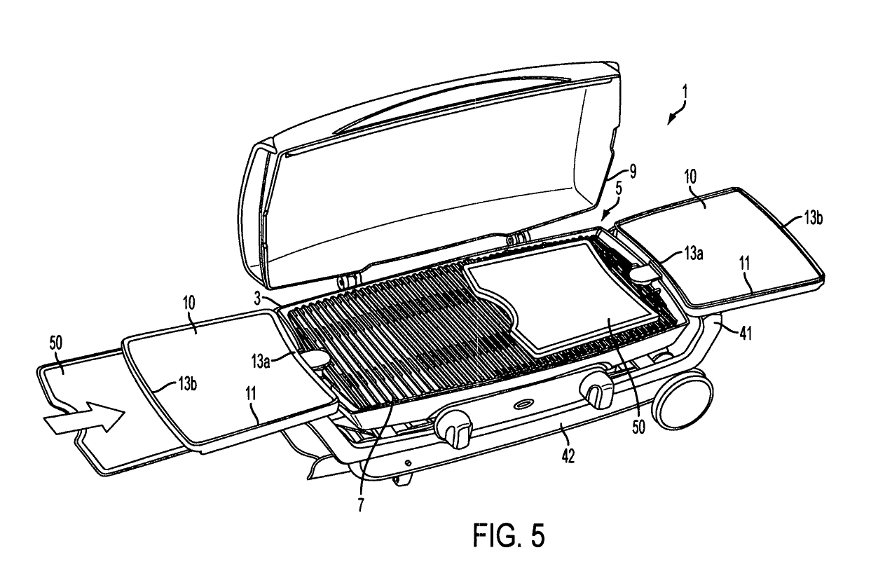

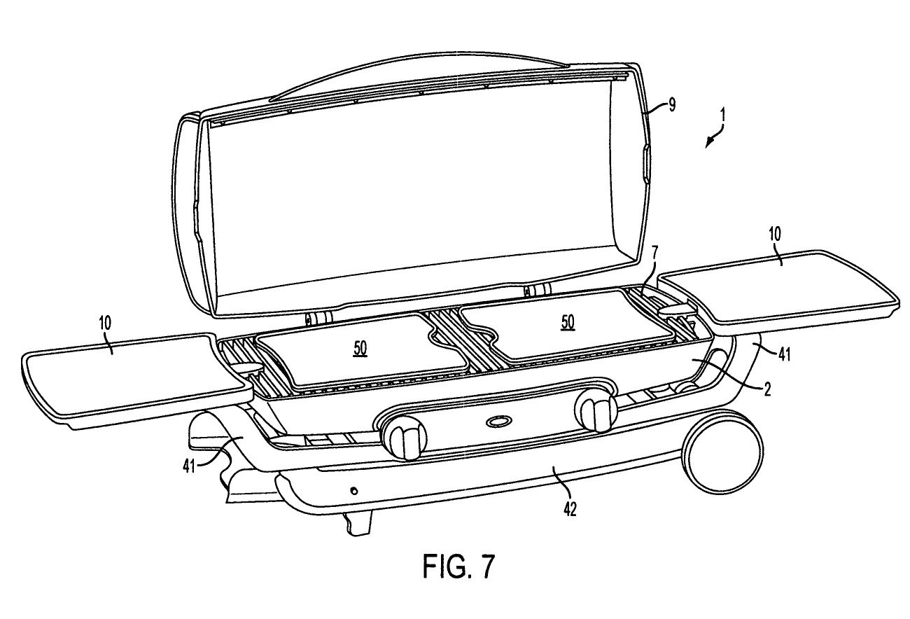

FIGS. 5-7 relate to another embodiment of a barbecue cooking apparatus 1 which comprises: a firebowl 2 having a peripheral edge 3, a bottomside 4 and a topside opening 5; at least one grill 7 situated over or upon the topside opening 5 of the firebowl 2; at least one shelf 10 having a topside surface 11 and an underside 12 designed to receive a griddle 50; and at least one griddle 50 designed to be received within the underside 12 of the shelf 10 during a storage position, and the griddle 50 is placed upon a topside surface 8 of the grill 7 during a usage position.

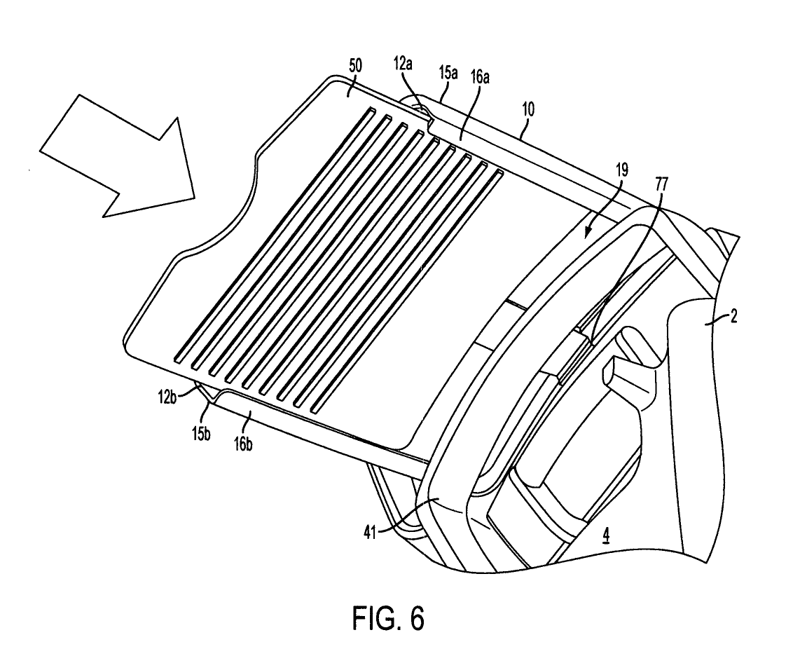

The underside 12 of the shelf 10 (as shown in FIG. 6) comprises at least two extended portions, 15a-b respectively, with lips, 16a-b respectively, situated on opposing sides, 12a-b respectively, of the underside 12 of the shelf 10. The two extended portions, 15a and 15b, with lips, 16a and 16b, of the underside 12 of the shelf 10 form a space 19 for receiving the griddle 50.

In a further embodiment, there are at least two shelves 10 having a topside surface and an underside designed to receive at least two griddles 50 designed to be received within the underside of each of the shelves 10 during a storage position, and each of the griddles 50 may be placed upon a topside surface of the grill during a usage position. In a further embodiment, the underside 12 of the shelf 10 has a detent 77 for holding the griddle 50 in place during storage or transport.

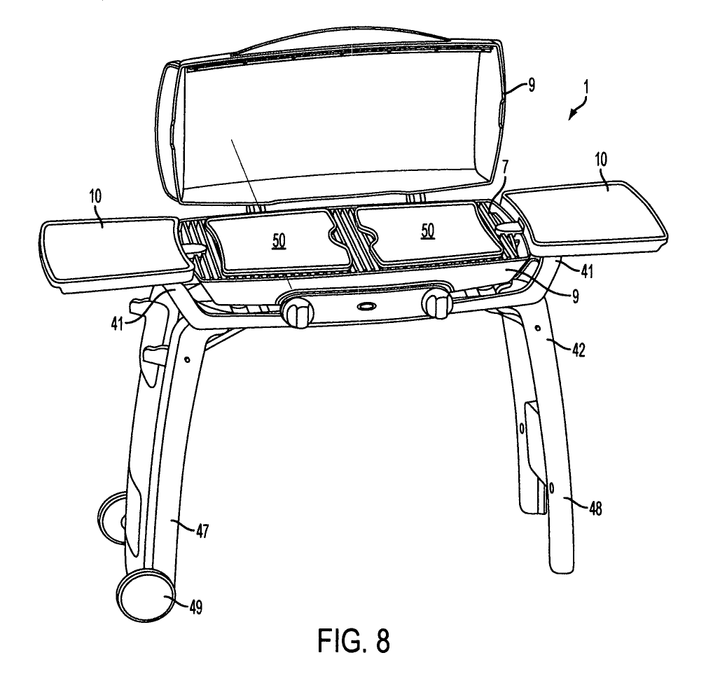

FIG. 8 shows the framework 42 with at least two legs, 47 and 48 respectively. There is a set of wheels 49 attached to at least one of the legs 47.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A cooking apparatus comprising:
a firebowl having a peripheral edge, a bottomside and a topside opening;
at least one grill situated over said topside opening of said firebowl;
at least one shelf having a topside surface and an underside designed to receive a griddle; and
at least one griddle designed to be received within said underside of said shelf during a storage position, said griddle is placed upon a topside surface of said grill during a usage position.

2. The apparatus of claim 1 wherein said firebowl has at least on aperture situated within said topside opening of said firebowl.

3. The apparatus of claim 2 wherein said shelf comprising opposing ends, at least one end comprises a protrusion.

4. The apparatus of claim 3 wherein said protrusion of said shelf is designed to fit within said aperture of said firebowl.

5. The apparatus of claim 4 wherein said protrusion is designed to rotate within said aperture of firebowl allowing said shelf to be pivotable and moveable.

6. The apparatus of claim 5 wherein said shelf is situated above said topside opening of firebowl during a non-use position, said shelf is pivotally moved away from said topside opening during a use position.

7. The apparatus of claim 1 wherein said underside of said shelf comprises at least two extended portions with lips situated on opposing sides of said underside of said shelf.

8. The apparatus of claim 7 wherein said two extended portions with lips of said underside of said shelf form a space for receiving said griddle.

9. The apparatus of claim 1 further comprises a cover pivotally attached a portion of said firebowl.

10. The apparatus of claim 1 further comprises a means for supporting said shelf during said use position.

11. The apparatus of claim 10 wherein said means is selected from a group consisting essentially of a base, a handle and a framework.

12. A cooking apparatus comprising:
a firebowl having a peripheral edge, a bottomside, a topside opening and at least on aperture situated within said topside opening of said firebowl;
at least one grill situated over said topside opening of said firebowl;
at least one shelf having a topside surface, an underside and opposing ends, at least one end of said shelf comprises a protrusion, said protrusion is designed to fit within and pivotally rotate within said aperture allowing said shelf to situated above said topside opening of said firebowl during a non-use position and then pivotally moved away from said topside opening during a use position.

13. The apparatus of claim 12 wherein said aperture is formed by a cylindrical element situated within said firebowl.

14. The apparatus of claim 13 wherein said protrusion of said shelf comprises a pin and a cap, said pin is designed to fit and rotate within said cylindrical element.

15. The apparatus of claim 14 wherein said cap is situated on a top portion of said pin and is designed to cover said cylindrical element.

16. The apparatus of claim 12 further comprising at least one griddle, said griddle is designed to fit on said underside of said shelf.

17. The apparatus of claim 16 wherein said underside of said shelf comprises at least two extended portions with lips situated on opposing sides of said underside of said shelf, said two extended portions with lips of said underside of said shelf form a space for receiving said griddle.

18. The apparatus of claim 12 further comprising a cover pivotally attached to a portion of said firebowl.

19. The apparatus of claim 12 further comprises a means for supporting said shelf during said use position, said means is selected from a group consisting essentially of a base, a handle and a framework.

20. A cooking apparatus comprising:
a firebowl having a peripheral edge, a bottomside, a topside opening and at least two apertures;
at least one grill situated over said topside opening of said firebowl;
at least two shelves, each having a topside surface and an underside designed to receive a griddle, each of said shelf having a protrusion designed to fit and pivotally rotate within each of said apertures of said firebowl allowing each of said shelves to be rotated in a first position situated over said grill and a second position away from said grill, said apertures of said firebowl are situated adjacent a portion of said peripheral edge of said firebowl; and
at least two griddles designed to be received within said underside of each of said shelves during a storage position, each of said griddles is placed upon a topside surface of said grill during a usage position.
